(19) United States
(12) Patent Application Publication
(10) Pub. No.: US 2007/0236474 A1
(43) Pub. Date: Oct. 11, 2007

(54) Touch Panel with a Haptically Generated Reference Key

(75) Inventor: Christophe Ramstein, San Francisco, CA (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Immersion Corporation, San Jose, CA (US)

(21) Appl. No.: 11/617,325

(22) Filed: Dec. 28, 2006

Related U.S. Application Data
(60) Provisional application No. 60/790,962, filed on Apr. 10, 2006.

(51) Int. Cl. G06F 3/041

(52) U.S. Cl. 345/173

(57) ABSTRACT

A touch panel provides an indication of a reference key and non-reference keys to a user. The touch panel senses a touch and determines the location of the touch. The touch panel then generates a haptic effect if the location is the reference key, and generates a different haptic effect if the location is a non-reference key.

### RELATED APPLICATIONS

This application claims the benefit of U.S. Provisional Patent Application No. 60/790,962 filed Apr. 11, 2006.

### FIELD OF THE INVENTION

One embodiment of the present invention is directed to a touch panel. More particularly, one embodiment of the present invention is directed to a user interface for a touch panel.

### BACKGROUND INFORMATION

Most standardized keyboards, such as a numeric keypad or a QWERTY (alphanumeric) keyboard, provide a raised area on one or more keys which serves as a reference. In a numeric keyboard, a raised portion, such as a bump, is placed on the top surface of the number “5” key to indicate that the particular button is the reference key. In QWERTY keyboards, raised areas are placed on the “F” and “J” keys to allow the user to easily locate those reference keys by the index fingers. Once the finger(s) is placed on the reference keys, the user is able to use prior knowledge of the locations of the remaining keys to operate the keys in the keyboard without having to look down at the keyboard.

Touchscreens, touch pads, a touch sensitive monitor, etc., which are collectively known as touch panels, have become more and more popular as input sources for computers and other devices. A touch panel typically includes a touch-sensitive input panel and a display device, usually in a sandwich structure. A touch is sensed by a touch panel when a finger or a stylus comes into contact with the outermost surface of the touch panel. The contact is translated into x and y coordinates of the finger or stylus location on the panel. Some touch panels are transparent overlays placed over a display, while other touch panels, such as touch pads, are nontransparent devices typically used to control cursor movement on a portable computer, for example, or as pen input devices for applications including writing or signature input to a computer. A touch panel can be installed in or near a computer, an automobile, ATM machines, etc.

However, touch panels generally do not have raised areas as described for the keyboards above. Accordingly, touch panels typically do not have the physical protrusion characteristics to provide the user with reference key information.

Based on the foregoing, there is a need for a system and method for providing a reference key to a user of a touch panel.

### SUMMARY OF THE INVENTION

One embodiment of the present invention is a touch panel that provides an indication of one or more reference keys and non-reference keys to a user. The touch panel senses a touch and determines the location of the touch. The touch panel then generates a haptic effect if the location is a reference key, and generates a different haptic effect if the location is a non-reference key.

### BRIEF DESCRIPTION OF THE DRAWINGS

FIG. 1 is a block diagram of a touch panel in accordance with one embodiment of the present invention.

FIG. 2 illustrates the QWERTY keyboard of a touch panel in accordance to one embodiment of the present invention with reference keys “F” and “J”.

FIG. 3 illustrates a non-standard keyboard portion of a touch panel in accordance to one embodiment of the present invention.

FIG. 4 is a flow diagram of the functionality performed by a touch panel in order to haptically generate a reference key in accordance with one embodiment of the present invention.

### DETAILED DESCRIPTION

One embodiment of the present invention is a touch panel that generates at least two different force feedback or vibrotactile feedback effects (collectively referred to herein as “haptic effects”) in response to a user contact, such as by a digit of a hand or with a stylus. The first haptic effect (e.g., a vibration) is provided to allow a user to locate one or more reference keys and the second haptic effect is provided to allow the user to locate a surface area of a key other than the reference key(s). With the location of the one or more reference keys established to the user, the remaining keys may be determined from the second haptic effect to locate the surrounding key surface. This is at least partially done utilizing the user's prior knowledge of the locations of the remaining keys. The user's knowledge may be based on a standard layout of the surrounding keys, such as with a generic numeric keypad or a QWERTY keyboard. The user's knowledge may alternatively be based on the user having learned the surrounding key locations of a specific device. As a result, the keyboard/keypad/or other haptically enabled touch panel can be used without requiring the user to continuously maintain eye contact on the surface.

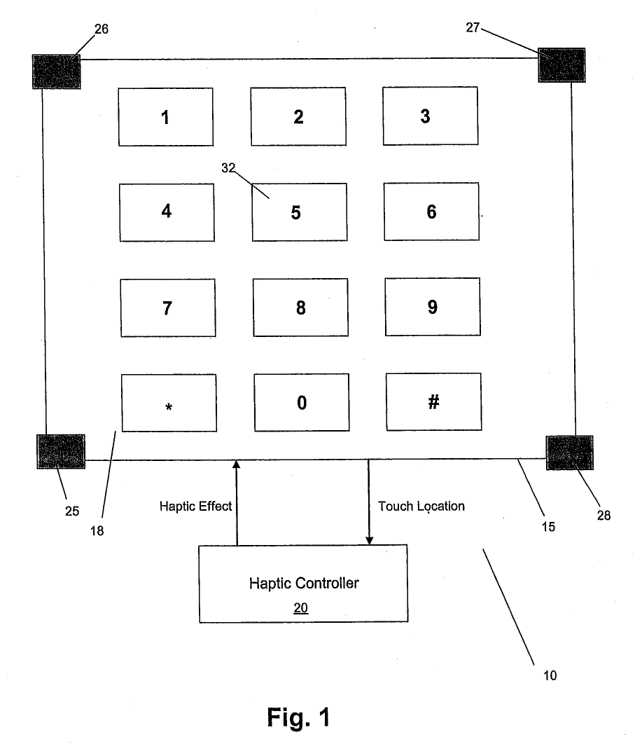

FIG. 1 is a block diagram of a touch panel 10 in accordance with one embodiment of the present invention. Touch panel system 10 includes a transparent touch sensitive surface 15 that is placed over a video screen 18. Touch sensitive surface 15 is designed and configured to sense the touch of a user's finger, stylus, or other object, and provide a touch location signal, such as the x and y coordinates, to a haptic controller 20. Touch sensitive surface 15 may be sensitive to, for example, pressure and/or heat through capacitive sensing, pressure sensing, or other means. Video screen 18 generates the keys and other characters and graphical objects that can be viewed by the user through touch sensitive surface 15.

Controller 20 includes a processor and memory for storing instructions that are executed by the processor. Controller 20 generates two or more haptic effects in response to receiving the touch locations, and can be a general purpose controller/computer that also performs other functions. Controller 20 may be in a location separate from touch sensitive surface 15 and video screen 18, or it may be integrated within those components.

Touch panel 10 further includes actuators 25-28 located at each corner of touch sensitive surface 15. Actuators 25-28 generate haptic effects in response to signals received from haptic controller 20. In one embodiment, the haptic effects are in the form of vibration, and different haptic effects can be generated by varying the magnitude, frequency and duration of the vibrations. Actuators 25-28 can include one or more force applying mechanisms which are capable of applying a vibrotactile force to a user of touch panel 10 (e.g., via touch sensitive surface 15). This force can be transmitted, for example, in the form of vibration movement caused by a rotating mass, a piezo-electric device, or other vibrating actuator type. Although in FIG. 1 actuators 25-28 are located at the corners of touch sensitive surface 15, in other embodiments one or more actuators can be used to generate the haptic effects, and the one or more actuators may located in other areas of touch panel 10.

In the embodiment shown in FIG. 1, touch panel 10 is a numeric keypad and key #5 (32) is a reference key. In other embodiments, however, touch panel 10 may be an alphanumeric QWERTY keyboard or may have a non-conventional key layout. In other embodiments, any other graphical object may be used besides alphanumeric keys as long as at least one graphical object functions as a reference object or key in relation to other graphical objects displayed on the screen of touch panel 10. Through programming, video screen 18 of FIG. 1 allows a variation of keys or graphical objects to be displayed. However, in other embodiments, such as a keypad, system 10 does not include video screen 18 and other methods of displaying keys, such as through silk screening or other permanent graphical display methods, on touch sensitive panel 15 can be used

The layout of the keys of touch panel 10 of FIG. 1 has the numbers 0-9 and other keys “*” and “#” and is configured as a standard layout found in most numerical keypads such as telephone and computer keypads. Controller 20 is configured to designate a first haptic signal to one or more reference keys, and cause actuators 25-28 to generate a haptic effect associated with the first haptic signal when touch sensitive surface 15 senses the user's finger touching reference key (32), which is the “5” key in the embodiment of FIG. 1.

Once the “5” key position is located with assistance of the first haptic effect, the user can move to the “2” key position, referred to as moving up, or move to the “8” key position, referred to as moving down, or move to other keys. This is accomplished by a combination of prior knowledge of the standardized keyboard layout (i.e., from memory), and through the use of a second haptic effect to indicate to the user that a non-reference key, such as the “2” or “8” key, is being touched.

In the embodiment of FIG. 1 having a numerical keypad, the contact area designated as the reference numeral 32, is haptically enabled so that touching key 32 generates a unique haptic response to the user. This unique haptic response alerts the user that the reference key has been touched. In one embodiment, an audio sound may be provided in addition to or alternatively to the unique haptic sensation.

In addition, when the user is navigating between different keys on touch screen 10, controller 20 will provide a different haptic signal to actuators 25-28, which will output a different haptic sensation to the user when the user touches the non-reference keys (keys 0-4, 6-9, “*”, and “#”). Therefore, each time the user contacts one or more non-reference keys (i.e., 1-4, 6-0 and */#), a second haptic effect will be felt. In one embodiment, during sliding contact on the screen, in areas not part of the numbered areas, no haptic effect will be generated.

The generation of a second haptic effect allows the user to locate reference key 32 as well as determine when the user is positioned over any key other than the reference key. Therefore, once a user locates reference key 32, the user can slide his/her finger up and out of the boundaries and will no longer feel any haptic effect once the finger leaves the boundaries of reference key 32. The user will then feel the second haptic effect once the user's finger enters the boundaries of a non-reference key, such as the “2” key. In this way, with only two distinct haptic effects, a user can navigate and select any desired key without the need for visual guidance.

In other embodiments, a third, fourth, etc. haptic effect can be generated by controller 20 and actuators 25-28 to impart more information to the user. For example, if a key is depressed, a third haptic effect can be generated. If contact pressure is maintained on that key, a fourth haptic effect can be generated. The third haptic can confirm the selection, and the fourth can add the same value multiple times to the input device or perform some other function. Alternately, removing and re-contacting the same numbered key can allow for multiple input of the same value to the input device. Further, in other embodiments, the sliding motion of a finger on touch screen 15 may generate a fifth haptic effect, and a sixth haptic effect may be generated when the finger encounters the edge of one of the keys.

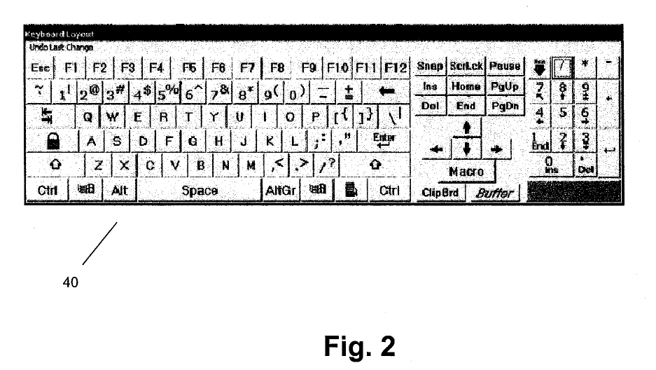

As disclosed, one embodiment of the invention may be directed to multiple reference keys on an alphanumeric keyboard displayed on a touch screen. In one embodiment, two haptic effects (i.e., two different feelings to a user) are generated for a standard QWERTY keyboard. FIG. 2 illustrates the QWERTY keyboard 40 of a touch panel in accordance to one embodiment of the present invention with reference keys “F” and “J”. The “F” and “J” keys (i.e., the surface area defining each key) are provided with a first haptic effect to a user and contact with the surface areas of the remaining alphanumeric keys, along with other keys, produces a second haptic effect. In this way, a user can locate the neutral keys (F & J) from which all other keys can be determined. The location of the letter keys, the number keys, the function keys (F1-F12), the shift key, the control, delete, insert, tab, caps lock, esc, etc. keys can all be located with these two haptic effects and the user's prior knowledge of the keyboard layout.

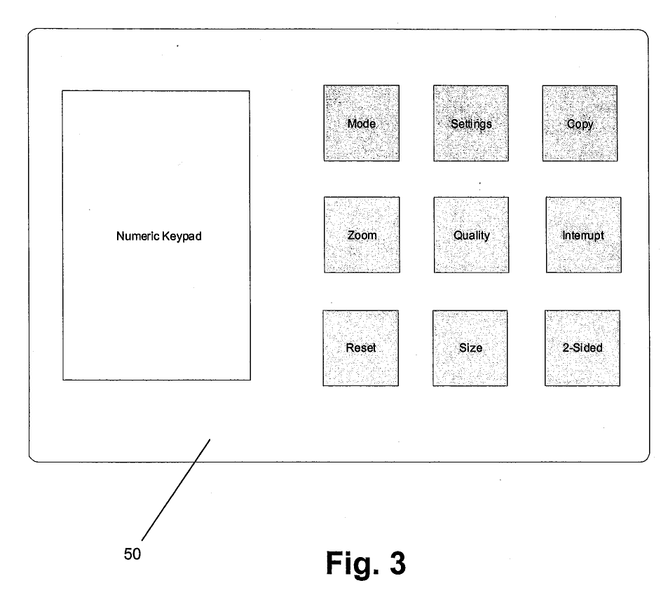

FIG. 3 illustrates a non-standard keyboard portion 50 of a touch panel in accordance to one embodiment of the present invention. A keyboard that is not “standard”, here a touch panel controlling a copier, may become “standardized” as a result of memory of the key locations gained through use and one or more of the keys may be designated as reference keys.

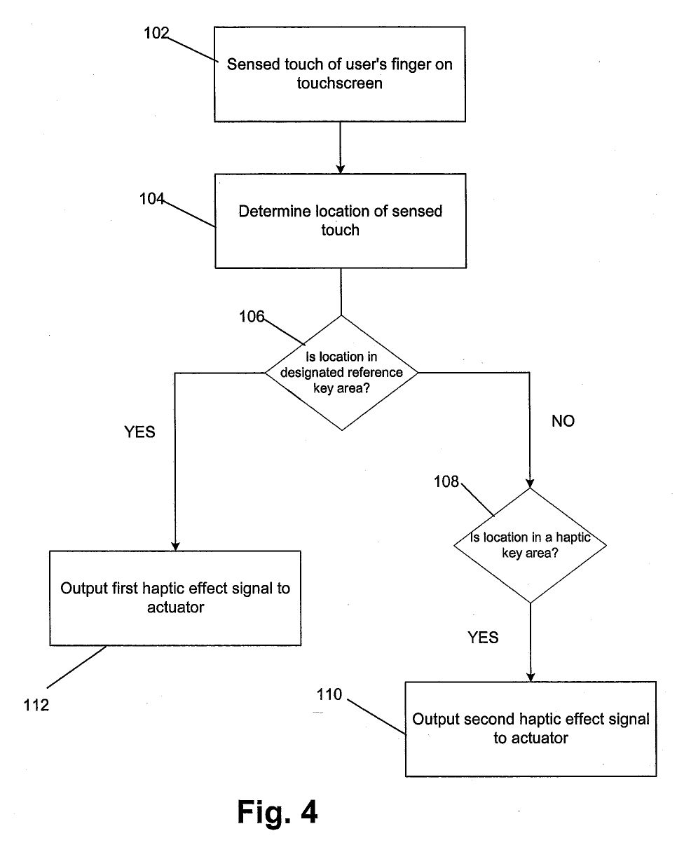

FIG. 4 is a flow diagram of the functionality performed by touch panel 10 in order to haptically generate a reference key in accordance with one embodiment of the present invention. In one embodiment, the functionality of FIG. 4 is implemented by software stored in a memory and executed by a processor. In other embodiments, the functionality can be performed exclusively by hardware, or by any combination of hardware and software. Further, in other embodiments, the touch panel, rather than being flat, may be curved or have other shapes, and the touch can be sensed by methods other than a touch sensitive surface, such as dome switches, membranes, etc.

The touch or contact of the user's finger on a key or other object on touch sensitive surface 15 is sensed (102). For a non-touch sensitive surface, a key may be pressed.

The location (e.g., x and y coordinates, or a determination of a key press for a non-touch sensitive embodiment) of the sensed touch is determined (104).

It is determined whether the location of the sensed touch from 104 is in a designated area associated with the reference key (106). For example, in the embodiment of FIG. 1, does the location coincide with reference key 32?

If the sensed location is within the designated reference key area, a first haptic effect signal is output to the actuator or actuators (112).

If the sensed location is not within the designated reference key area, it is determined whether the sensed location is in a haptic key area other than the reference key (108). If so, a second haptic effect signal is output to the actuator or actuators (110). If not, no haptic effect is output by touch system 10.

As disclosed, embodiments of the present invention haptically enable a one or more reference keys and non-reference keys on a touch panel. This allows a user to locate the reference key(s) and subsequently the remaining keys without requiring visual contact with the touch panel. As a result, a visually impaired user will more easily utilize the touch panel, as well as a user who cannot easily view the touch panel, such as when the touch panel is implemented in a vehicle and it is desirable for the user to maintain eye contact with the road rather than the touch panel.

Several embodiments of the present invention are specifically illustrated and/or described herein. However, it will be appreciated that modifications and variations of the present invention are covered by the above teachings and within the purview of the appended claims without departing from the spirit and intended scope of the invention.

For example, although the haptic effect of vibration is disclosed in the above embodiments, any type of haptic effect involving forces, vibrations and/or motions (e.g., deformable surfaces) can be used.

What is claimed is:

1. A method of operating a touch panel comprising:
sensing a contact on the touch panel;
determining a location of the contact;
generating a first haptic effect if the location is a reference key on the touch panel; and
generating a second haptic effect if the location is a non-reference key on the touch panel.

2. The method of claim 1, wherein said touch panel comprises a standardized keyboard.

3. The method of claim 1, wherein said touch panel comprises a plurality of keys, further comprising:
generating a third haptic effect if the location is a portion of said touch panel other than the plurality of keys.

4. The method of claim 1, wherein said first and second haptic effects are vibrotactile effects.

5. The method of claim 1, further comprising:
generating a third haptic effect if the contact indicates a sliding contact on the touch panel.

6. The method of claim 1, wherein said determining the location comprises determining an x and y coordinate of a location of the contact.

7. The method of claim 2, further comprising determining an identity of the non-reference key based on the second haptic effect and a knowledge of the standardized keyboard.

8. A touch panel comprising:
a touch sensitive surface having a plurality of graphical objects representing a keyboard;
an actuator coupled to said touch sensitive surface; and
a controller coupled to said actuator;
wherein said keyboard has a reference key and a non-reference key, and said controller is configured to generate a first haptic signal when said reference key is contacted and a second haptic signal when said non-reference key is contacted.

9. The touch panel of claim 8, wherein said actuator generates a first haptic effect in response to said first haptic signal, and generates a second haptic effect in response to said second haptic signal.

10. The touch panel of claim 8, further comprising a video screen that generates said graphical objects coupled to said touch sensitive surface.

11. The touch panel of claim 8, wherein said keyboard is a standardized QWERTY keyboard.

12. The touch panel of claim 8, wherein said keyboard is a standardized numeric keypad.

13. The touch panel of claim 8, wherein said actuator comprises a vibration generating device.

14. A computer readable medium having instructions stored thereon that, when executed by a processor, causes the processor to:
sense a touch on a touch panel;
determine a location of the touch;
generate a first haptic effect if the location is a reference key on the touch panel; and
generate a second haptic effect if the location is a non-reference key on the touch panel.

15. The computer readable medium of claim 14, wherein said touch panel comprises a standardized keyboard.

16. The computer readable medium of claim 14, wherein said touch panel comprises a plurality of keys, said instructions further causing said processor to:
generate a third haptic effect if the location is a portion of said touch panel other than the plurality of keys.

17. The computer readable medium of claim 14, wherein said first and second haptic effects are vibrotactile effects.

18. The computer readable medium of claim 14, said instructions further causing said processor to:
generate a third haptic effect if the touch indicates a sliding contact on said touch panel.

19. A method of interfacing with a user of a touch panel comprising:
determining whether the user has selected a reference key of the touch panel; and
generating a first haptic effect on the touch panel if the reference key has been selected.

20. The method of claim 19, further comprising:
determining whether the user has selected a non-reference key of the touch panel;
generating a second haptic effect on the touch panel if the non-reference key has been selected.

21. The method of claim 20, wherein said first haptic effect and said second haptic effect is a vibrotactile effect.

22. The method of claim 20, wherein said touch panel comprises a standardized keyboard.

23. The method of claim 22, further comprising determining an identity of the non-reference key based on the second haptic effect and a knowledge of the standardized keyboard.
